(19) United States
(12) Patent Application Publication
(10) Pub. No.: US 2003/0011084 A1
(43) Pub. Date: Jan. 16, 2003

(54) Gas-liquid tray

(76) Inventors: Bernardinus Henricus Bosmans, Amsterdam (NL); Wilhelmus Adrianus Theodorus Uijen, Amsterdam (NL)

Correspondence Address: Richard F Lemuth, Shell Oil Company, Intellectual Property, PO Box 2463, Houston, TX, 77252-2463, US

(21) Appl. No.: 10/204,080

(22) PCT Filed: Feb. 16, 2001
(86) PCT No.: PCT/EP01/01809

(30) Foreign Application Priority Data
Feb. 16, 2000 (EP) OO200520.5

(51) Int. Cl. B01F 3/04

(52) U.S. Cl. 261/114.1

(57) ABSTRACT

Gas-liquid contact tray comprising a bubble area and one or more rectangular downcomer openings spaced within the bubble area, wherein a shield provided with a plurality of openings is present above the downcomer opening and which shield extends from both the longitudinal sides of the rectangular downcomer.

The invention is directed to an improved gas liquid contacting tray comprising a bubble area and a downcomer opening. Such trays are well known as distillation column internals as described in Distillation Design, Henry Z. Kister, McGraw-Hill Inc., 1992, pages 259-267.

When trying to increase the liquid and/or gas flows of the gas-liquid contacting columns as described above a maximum load will be observed. Higher loads will result in that the column fails to function as a liquid-gas contactor or separator due to a phenomena known as flooding. Flooding is described as excessive accumulation of liquid inside the column. The well known flooding mechanisms are downcomer back-up, jet flooding and downcomer choking. These mechanisms are described in Distillation Design, Henry Z. Kister, McGraw-Hill Inc., 1992, pages 267-291. According to this publication downcomer back-up is due to a build-up of liquid inside the downcomer causing the liquid to back-up on the tray leading to liquid accumulation on that tray. The liquid height in the downcomer is determined by the tray pressure drop, liquid height on the tray and frictional losses in the downcomer and downcomer slot area. Jet flooding or entrainment flooding is caused by a too high gas velocity leading to the entrainment of liquid, either by droplets or froth, to the tray above. The liquid will accumulate and leads to flooding. Downcomer choking is caused by a too high aerated liquid velocity in the downcomer. At a certain velocity the friction losses in the downcomer and downcomer entrance become excessive, and the frothy gas-liquid mixture (froth) cannot be transported to the tray below, causing liquid accumulation on the tray. With the term froth is to be understood any gas-liquid mixture present on the tray not depending on any flow regime.

U.S. Pat. No. 3,231,251 describes a gas-liquid contacting tray provided with a so-called froth disengaging gas permeable element. This element is positioned between downcomer opening and the space above the bubble area which is occupied by froth. The element extends vertically from the weir to the next tray above. The disclosed element is a woven or knitted crimped wire mesh. According to the specification the liquid handling capacity of a column provided with such trays is improved.

A disadvantage of the tray according to U.S. Pat. No. 3,231,251 is that the knitted mesh is sensitive for fouling. A further disadvantage is that the elements extend to the next tray. This feature results in that the disclosed froth disengaging element is less suited for the more complex tray layouts comprising multiple downcomers. A next disadvantage is that the elements are fixed to two trays. This makes installation of the trays in a column more complex. A further disadvantage is that such a tray is inherently mechanically unstable.

FR-A-2046521 discloses a process to contact a gas and liquid in a column provided with trays. Between the contact trays free flowing mixing enhancers are present. These enhancers are solids elements which are present in the froth. In order to avoid that these elements flow to a lower tray via the segmental downcomers a shield is present between the space occupied by the froth and the downcomer opening.

The problem to be solved by the present invention is to provide a gas-liquid contact tray having an increased capacity and an increased froth handling capacity of its downcomer, which tray does not have the disadvantages of the tray as disclosed in U.S. Pat. No. 3,231,251.

This object is achieved with the following tray.

Gas-liquid contact tray comprising a bubble area and one or more rectangular downcomer openings spaced within the bubble area, wherein a shield provided with a plurality of openings is present above the downcomer opening and which shield extends from both the longitudinal sides of the rectangular downcomer.

Applicants have found that the tray according to the invention shows a capacity improvement when compared to a tray not having a shield. A further advantage is that it can be applied to more complex tray layouts comprising more than one rectangular downcomer and optionally one or more segmental downcomers. A next advantage is that the shield is fixed to one tray only making installation of said trays into a column more simple. Further advantages of the invention will become apparent when reading the below description.

Rectangular formed downcomers have a width which is smaller than its length. The rectangular downcomer according to the present invention has bubble area at both of its elongated sides. The position of the shield should be such that it interacts with the froth moving from a position above the bubble area to the downcomer opening. The shield can have any form, provided that it starts at one longitudinal side of the downcomer opening, runs above the downcomer opening at least above tray level, and ends at the opposite longitudinal side of the downcomer. The shield may for example be curved or hooked having one, two or more hooks as seen along the longitudinal axis of the rectangular downcomer opening. An opening between the space occupied with the froth and the rectangular downcomer opening may be present at the two outer ends of the rectangular downcomer.

In a preferred embodiment the shield consists of two rectangular flat plates provided with holes. Each plate extends from a corresponding longitudinal side of the downcomer to a position above the downcomer opening where they meet and are suitably fixed together. Preferably the angle between the vertical and each plate is less than 60 degrees and more preferably less than 30 degrees.

The rectangular downcomer is preferably provided with an anti-jump baffle vertically positioned in the downcomer opening in the longitudinal direction of said opening, suitably along the longitudinal centre of said opening. This anti-jump baffle plate preferably extends to between 30 and 80% of the tray spacing above the tray level. The lower end of this baffle may extend from tray level to the downcomer lower end. Preferably the anti-jump baffle is supported by the shield by fixing the shield to the upper part of the anti-jump baffle above the downcomer opening. This is advantageous because the normal support structure of the anti-jump baffle can thus, partly or in whole, be replaced by the shield.

Preferably the shield extends above tray level to at most between 15 and 95% of the tray distance and more preferably between 50 and 80% of the tray distance. The tray distance is the distance between two consecutive contact trays in a gas-liquid contacting column provided with the trays according the invention. Suitably this distance is between 0.2-1 m.

The shield is provided with openings, which openings may have any form and can optionally be provided with flow direction means. Furthermore the openings should be large enough to permit an easy and continuous flow of the froth through the shield and into the downcomer opening. The preferred size of the openings in the shield will be defined by making use of the Sauter mean diameter and the hydraulic diameter. The Sauter mean diameter is the quotient of the volumetric mean diameter with the surface area mean diameter of the bubble or droplet in the froth (see also Hetsroni G, Handbook of Multiphase systems, Hemisphere publishing corporation 1982 pages 10-105). Depending on the regime above the tray bubbles or droplets will be present in the froth. Preferably the hydraulic diameter of an opening is more than 0.8, more preferably more than 1 and most preferably more than 1.5 times the Sauter mean diameter of the bubble or droplet in the froth. The maximum hydraulic diameter is preferably 100 mm, more preferably 50 mm.

The shield is preferably a flat, curved or hooked plate of enough strength to withstand the conditions in a gas-liquid contact column. Preferably the shield is made from a metal plate, preferably stainless steel, provided with openings. The net free area of such a shield or otherwise said the area of the openings relative to the shield area is preferably between 25 and 80%. The open area may vary as a function of the height of the shield, wherein preferably a smaller open area is present at the upper part of the shield. The openings are suitably made by punching, drilling or protruding an opening or by mechanical or laser cutting. A most preferred shield is made from expanded metal, because of its availability and simplicity of fabrication and strength. Expanded metal typically has openings in the form of a slit having an elongated length and a shorter height. The slits may for example have a trapezoidal, rhombus shaped or hexagonal form.

Preferably a weir is present on the tray. A weir is a device positioned on or about on the boundary of the bubble area and the downcomer opening which ensures that a certain pre-selected amount of liquid is present on the upper surface of the bubble area. The height of the weir may be selected from conventional values known for well known designs as exemplified below. The shield may suitably be positioned on top of the weir or alongside of the weir. The shield and weir can optionally be combined in one element having no, very few or very small openings at its lower end, in order to maintain a certain pre-selected amount of liquid. Existing trays provided with a weir are suitably retrofitted by fixing the shield on top of the existing weir.

The weir may suitably be inclined towards the direction of the liquid flowing towards the downcomer opening. To further increase the liquid handling capacity of the tray the overflow weir is preferably inclined towards the bubble area, such that an imaginary line, drawn from the top of the overflow weir to the base of the overflow weir, forms an angle α with the horizontal plane of the tray which is smaller than 80° and more preferably larger than 30°. The overflow weir height lies preferably in the range from 25 mm to ⅙ of the height of the tray spacing, wherein tray spacing is the distance between two consecutive contacting trays when placed in a column.

For the present invention it is not critical which kind of gas openings are used in the bubble area of the tray. Examples are sieve tray openings, valve tray openings, bubble cap openings and fixed valve openings. Examples of these openings can be found in general text books such as the aforementioned general textbook of Kister on pages 260-267 and in U.S. Pat. No. RE 27,908, U.S. Pat. No. 5,120,474, WO-A-9828056, WO-A-9737741, U.S. Pat. Nos. 5,911,922, 3,463,464 and 5,454,989.

The vertical shape of the rectangular downcomer is not critical for the present invention. The downcomer wall may optionally be inclined relative to the vertical axis of the column in which the trays are used. The invention is especially suited for multiple downcomer designs as for example described in GB-A-1422132 and GB-A-1422131.

In one preferred embodiment of the invention a shield is provided in combination with a gas-liquid contacting tray having a tray layout as described as follows. The layout is such that the tray is divided in two tray sections by a diametrical line, each tray section provided with a row of rectangular downcomers, the downcomers arranged perpendicular to the diametrical line such that the ends of the downcomers of each tray section meet this line in an alternating fashion. Preferably a segmental downcomer is present in each tray section at the intersection of the diametrical line and the column wall. When placed in a gas-liquid column consecutive trays are preferably mirror images of each other with respect to downcomer layout and mirrored along the diametrical line. This so-called staggered arrangement has proven to be an efficient gas-liquid contacting tray. By combining this known tray layout with the shields an even more efficient gas-liquid contacting tray is obtained.

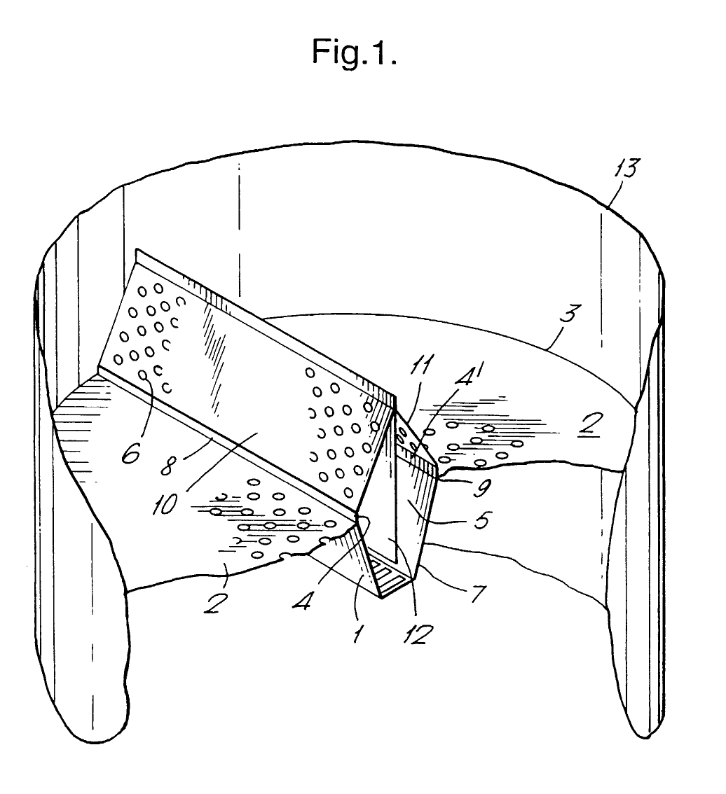

The invention will be further schematically illustrated by making use of FIG. 1.

FIG. 1 is a three dimensional view of a rectangular downcomer showing part the gas-liquid tray according to the invention.

FIG. 1 shows a rectangular downcomer (1) spaced in bubble area (2) on gas-liquid contact tray (3). For simplicity only one downcomer (1) is shown. A weir (4) and a downcomer opening (5) are shown. As a shield (6) two flat plates of expanded metal (10, 11) extends from each weir (4, 4′) positioned at the elongated sides (8, 9) of the downcomer opening (5). The plates of expanded metal (10, 11) are fixed to an anti-jump baffle (12) at a point above the downcomer opening (5), such that they support said anti-jump baffle (12). FIG. 1 also shows a downcomer wall (7) and part of a column wall (13).

The tray according to the invention is preferably used in a gas-liquid contacting column, which column is provided with these trays, axially spaced away from each other. Preferred gas-liquid contacting columns are distillation and absorption columns. In absorption processes a downwardly moving liquid is contacted with a upwardly moving gas and one or more components is transferred from the gas to the liquid or vice versa. In a distillation process one or more components are separated from a feed due to differences in their boiling points. In a distillation process the feed is typically supplied to an intermediate position in the column, wherein trays are present above and below said inlet position. Such a column is further provided with reboiler, condensation and reflux means. No free flowing solid mixing enhancing elements are present in the froth.

Because of the simplicity of the shield it is very easy to install such a shield in an existing distillation column and arrive at a tray according to the invention. In this manner a simple method of increasing the capacity of an existing distillation column is provided for.

1. Gas-liquid contact tray comprising a bubble area and one or more rectangular downcomer openings spaced within the bubble area, wherein a shield provided with a plurality of openings is present above the downcomer opening and which shield extends from both the longitudinal sides of the rectangular downcomer.

2. Tray according to claim 1, wherein the shield is made from expanded metal.

3. Tray according to any one of claims 1-2, wherein the shield comprises of two rectangular flat parts, each part extending upwards from one longitudinal side of the downcomer opening and which two parts are fixed at a position above the downcomer opening.

4. Tray according to claim 3, wherein the angle between the plane of each flat part of the shield and the vertical is smaller than 60 degrees.

5. Tray according to any one of claims 1-4, wherein the rectangular downcomer opening is provided with an anti-jump baffle vertically positioned along the longitudinal centre of the downcomer opening.

6. Tray according to claim 5, wherein the anti-jump baffle is supported by the shield.

7. Column comprising a plurality of trays according to any one of claims 1-6.

8. Column according to claim 7, wherein the vertical height of the shield above the tray level is between 50 and 80% of the tray spacing, wherein tray spacing is the distance between two consecutive trays.

9. Method to retrofit an existing gas-liquid contacting column comprising a plurality of axially spaced trays comprising a bubble area and one or more rectangular downcomer openings by adding a shield to the trays in such a manner that a tray according to claims 1-6 is obtained or a column according to claims 7 or 8.

10. Use of a column according to claim 7 or 8 or obtained by the method of claim 9 as distillation or absorption column.

11. Use according to claim 10, wherein the openings in the shield have a hydraulic diameter which is at least 1.5 times greater than the Sauter mean diameter of the droplets or bubbles present in the froth above the tray.
